(19) United States
(12) Patent Application Publication
(10) Pub. No.: US 2002/0189141 A1
(43) Pub. Date: Dec. 19, 2002

(54) Calendar for administrating medicine as prescribed

(75) Inventors: Masao Yamamoto, Tokyo (JP); Masashi Takayama, Osaka-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Kabushiki-Kaisha Musshu, Tokyo (JP)

(21) Appl. No.: 09/972,220

(22) Filed: Oct. 5, 2001

(30) Foreign Application Priority Data
Jun. 14, 2001 (JP) 2001-180078
Aug. 1, 2001 (JP) 2001-233113

(51) Int. Cl. G09D 3/00

(52) U.S. Cl. 40/107

(57) ABSTRACT

Designations on the part of the day for which the medicine is to be taken are indicated on the respective date section of the calendar, and an administration instructing tag is attached to the intended one of the designations on the part of the day in order to administrate medicine without fail. After taking the medicine, the medicine pouch or the tag can be displaced to the next designation on the part of the day.

A calendar for administrating medicine of the present invention is provided on the respective date section thereof with designated parts 4 of the day such as “morning”, “midday”, and “evening” for which the medicine is to be taken, wherein a medicine pouch 2 can be attached removably on the designated part on the day of the calendar.

### BACKGROUND OF THE INVENTION

1. Technical Field

The present invention relates to a calendar for administrating official medicine delivered from hospital or dispensary as prescribed at the designated part of the day.

2. Description of the Prior Art

In the case of official medicine delivered from hospital or dispensary, it is necessary to take the medicine as prescribed to obtain the sufficient therapeutic effect. However, the medicine is sometimes failed to be taken.

In the case of the prior art, the medicine cabinets in which medicines for each day are stored within one section thereof separately are provided. The one of these cabinets includes a plurality of drawers on which the date is designated. The other cabinet has partitions subdividing the interior of the cabinet to days. However, the subdividing operation of the medicine into days requires much labor, and the medicine cannot necessary be taken as prescribed.

Accordingly the object of the present invention is to indicate on the respective date section of the calendar designations on the part of the day for which the medicine is to be taken, and attach a medicine pouch or an administration instructing tag to the intended one of the designations on the part of the day in order to administrate medicine without fail. The displacement of the medicine pouch or the tag to the next designations on the part of the day can be made easily after taking the medicine.

### SUMMARY OF THE INVENTION

In order to establish the object of the present invention, a calendar for administrating medicine in accordance with claim 1, is a calendar on the respective date section thereof is provided with designations on the part of the day such as “morning”, “midday”, and “evening” for which the medicine is to be taken.

The calendar for administrating medicine in accordance with claim 2, is a calendar on the respective date section thereof is provided with designations on the part of the day such as “morning”, “midday”, and “evening” for which the medicine is to be taken, and a medicine pouch to be attached removable on one of the designations on the part of the day.

The calendar for administrating medicine in accordance with claim 3, is a calendar comprising:

a calendar on the respective date section thereof is provided with designations on the part of the day such as “morning”, “midday”, and “evening” for which the medicine is to be taken and is provided with engaging openings on the portions corresponding to each part of the day; and

a tag including a head and a hook connected by a neck of reduced width, wherein the head of the tag is inserted through an opening formed on the upper portion of a medicine pouch, and then the tag is inserted with the pouch through the intended one of the engaging openings to engage the head with the back side of the sheet of the calendar to hang the medicine pouch.

The calendar for administrating medicine in accordance with claim 4, is a calendar according to claim 3, wherein:

the tag is made of a material of slight elasticity, and the breadth of the head is larger than the diameter of the engaging opening, so that the head is urged to be deformed to reduce the breadth thereof to the lateral width of the engaging opening upon inserted into the engaging opening and then recovered elastically to its original shape on the back side of the sheet and engaged with the back side.

The calendar for administrating medicine in accordance with claim 5, is a calendar on the respective date section thereof is provided laterally with designations on the part of the day such as “morning”, “midday”, and “evening” for which the medicine is to be taken, and is also provided with laterally aligned engaging openings on the portions corresponding to the parts of the day, the engaging openings are communicated with each other through a slit or communicating portion; and

a tag including a head and a hook connected by a neck of reduced width, wherein the head of the tag is inserted through an opening formed on the upper portion of a medicine pouch, and then the tag is inserted with the pouch through the intended one of the engaging opening to engage the head with the back side of the sheet of the calendar to hang the medicine pouch.

The calendar for administrating medicine in accordance with claim 6, is a calendar on the respective date section thereof is provided with designations on the part of the day such as “morning”, “midday”, and “evening” for which the medicine is to be taken, wherein an administration instructing tag can be attached removably on the calendar.

The calendar for administrating medicine in accordance with claim 7, is as claimed in claim 6 wherein the administration instructing tag can be attached removably by an adhesive mass good at its releasability.

The calendar for administrating medicine in accordance with claim 8, is a calendar on the respective date section thereof is provided laterally with designations on the part of the day such as “morning”, “midday”, and “evening” for which the medicine is to be taken, and is also provided with laterally aligned engaging openings on the portions corresponding to the parts of the day, the engaging openings are communicated with each other through a slit or communicating portion; and

an administration instructing tag including a head and a hook connected by a neck of reduced width, wherein the head of the administration instructing tag is inserted through an opening formed on the upper portion of a medicine pouch, and then the administration instructing tag is inserted with the pouch through the intended one of the engaging opening to engage the head with the back side of the sheet of the calendar to hang the medicine pouch.

### BRIEF DESCRIPTION OF THE DRAWINGS

Further feature of the present invention will become apparent to those skilled in the art to which the present invention relates from reading the following specification with reference to the accompanying drawings, in which:

FIG. 1a is a plan view showing a calendar of the present invention;

FIG. 1b is an enlarged plan view showing a portion of the calendar of the present invention;

FIG. 2 is a plan view showing a tag;

FIG. 3 is an enlarged plan view showing an engaging opening;

FIG. 4 is a plan view showing a memorandum card;

FIG. 5 is a plan view showing a medicine pouch;

FIG. 6 is a plan view showing a calendar of another embodiment of the present invention;

FIG. 7 is an enlarged plan view showing engaging openings;

FIG. 8 is a perspective view showing a medicine pouch of another embodiment;

FIG. 9 is a plan view showing an example of the administration instructing tag; and

FIG. 10 is a plan view showing another example of the administration instructing tag.

### DETAILED DESCRIPTION OF THE PRESENT INVENTION

The preferred embodiments in accordance with the present invention will now be described with reference to the attached drawings.

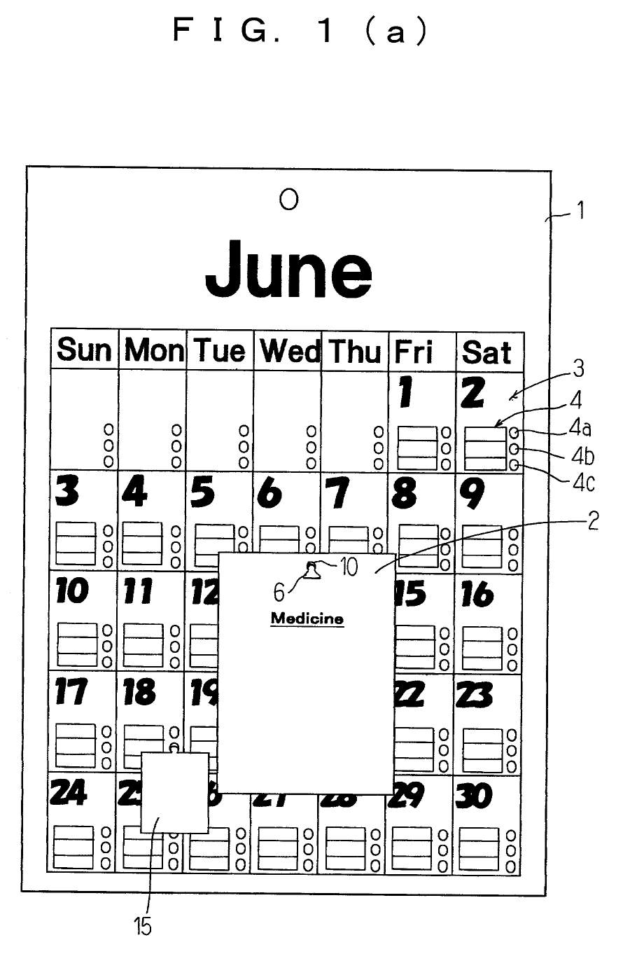

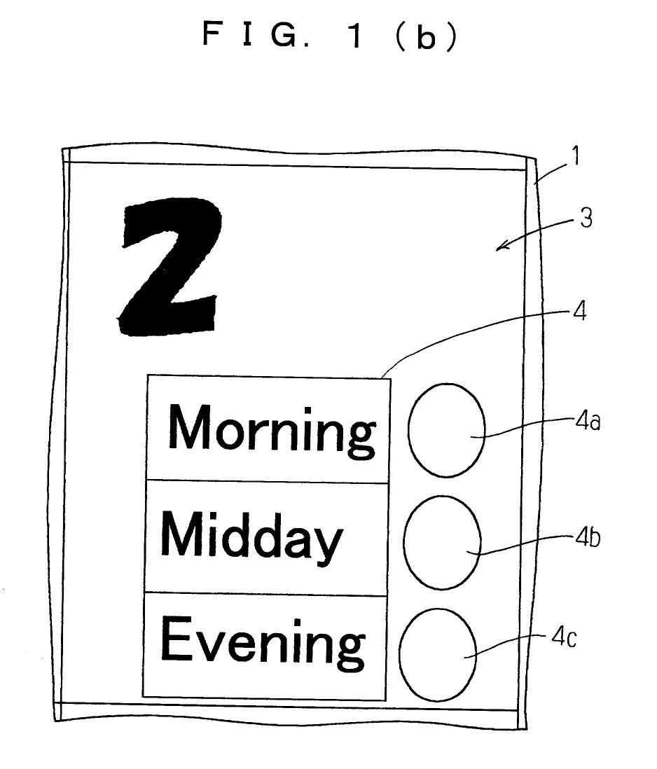

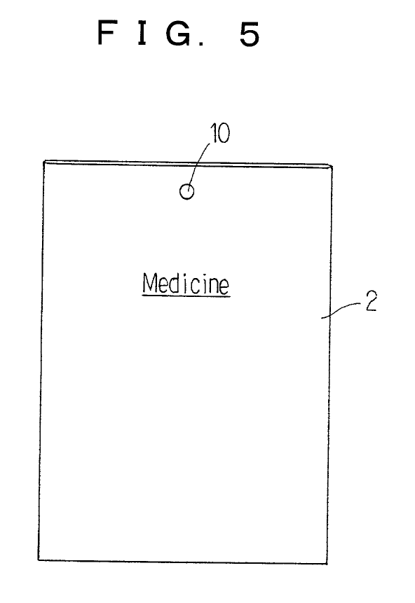

The calendar 1 for administrating medicine in accordance with an embodiment of the present invention is printed on a sheet. The calendar includes designations of dates of one month as shown in FIG. 1. Each date section 3 subdivided by frames also has designations 4 on the part of the day such as “morning”, “midday”, and “evening” for which the medicine is to be taken. Further, oblong engaging openings 4a, 4b, and 4c corresponding to each designation on the part of the day respectively are provided through the sheet. A medicine pouch 2 (see FIG. 5) is adapted to be hanging on the opening by means of a tag 6.

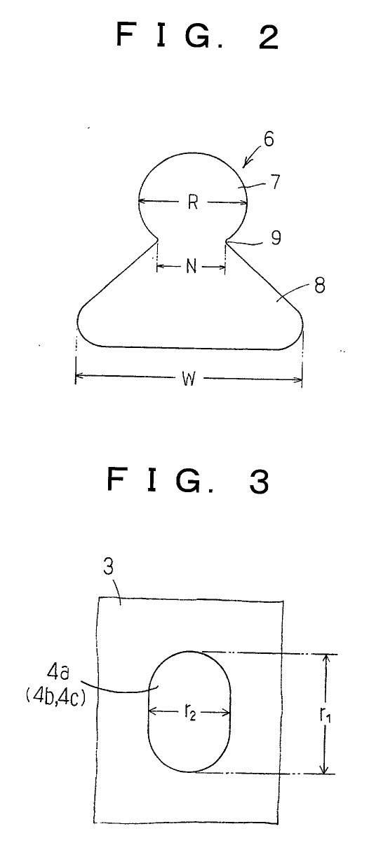

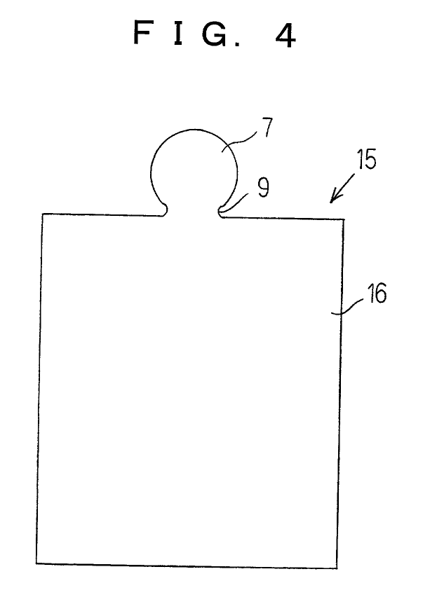

The tag 6 has as shown in FIG. 2 a substantially circular head 7 and a substantially equilateral triangle shoulder 8 connected to the head through a neck 9 of the reduced width. The tag is made preferably of a thin paperboard or a sheet of synthetic resin. Upon employing the tag 6, the head 7 is inserted through an opening 10 provided through the upper marginal portion of the medicine pouch 2 with engaging the shoulder 8 of the tag with the opening 10, and into one of the engaging openings so as to position the head opposite to the back side of the sheet. Thus, the medicine pouch 2 can be hanged by means of the tag.

The dimensional relation between each of the engaging openings 4a, 4b, and 4c and the tag 6 will now be described.

The head 7 of the tag 6 is adapted to be inserted into one of the engaging openings and then engaged with the backside of the sheet of the calendar. In this connection, the breadth (R) of the head 7 is larger than the width (r₂) of the engaging opening along the minor axis or the lateral width, and smaller than the width (r₁) of the engaging opening along the major axis or the longitudinal width, and the width (N) of the neck 9 is smaller than the lateral width (r₂).

Thus the relationship as expressed below can be obtained between the breadth (R) of the head 7, the lateral width (r₂) and the longitudinal width (r₁) of the engaging openings 4a, 4b, 4c, and the width (N) of the neck 9.

r₁≧R>r₂>N

The breadth (W) of the shoulder 8 is larger than the diameter of the opening 10 provided through the medicine pouch 2, and the breadth (R) of the head 7 is smaller than the diameter of the opening 10.

An example of the method for attaching the medicine pouch 2 to the calendar of the structure as mentioned above will now be described.

At first the head 7 of the tag 6 is inserted into the opening 10 formed through the upper marginal portion of the medicine pouch 2 with aligning the breadth of the head with the major axis of the engaging opening, and then the head 7 is inserted into the desired one of the engaging openings 4a, 4b, 4c so as to position the head opposite to the back side of the sheet of the calendar.

Upon the neck 9 reached the position of the engaging opening, the tag 6 is rotated around 90°.

The head 7 is then engaged with the backside of the sheet of the calendar since the breadth (R) of the head is larger than the lateral width of the engaging opening 4a, 4b, 4c. Thus the medicine pouch 2 is hanged stably by resting the marginal portion around the opening 10 on the left and right upper edges of the shoulder 8.

When it is intended to take the pouch out, it can be achieved by rotating the tag around 90° to align the breadth of the head with the major axis of the engaging opening, and pull it out.

Although in the above mentioned embodiment the engaging openings are of oblong shape larger in their vertical dimension, engaging openings of circular configuration may also be adopted. In such a case, the tag 6 may preferably be made of elastic material for example paperboard or sheet of synthetic resin so as to enable the head 7 to deform or reduce the breadth thereof upon inserted into the engaging opening 4a, 4b, 4c. Then the head may recover its original breadth, and engage with the backside of the sheet. Further the tag may preferably be formed of an material of hardly tear out.

As shown in FIG. 1, a memorandum card 15 for designating the required information such as the next reservation on the medical consultation can also be attached to the corresponding date of the calendar. The memorandum card 15 also has a head 7 substantially the same as that of the tag 6. The head is connected through a neck 9 to the body 16 of the card. The manner of connection of the card to the engaging opening 4a, 4b, 4c is the same as that employed on the tag 6. The medicine pouch can also be hanged through the memorandum card rather than the tag.

An illustrative example of the method of utilizing the calendar of the present invention of the structure as mentioned above will now be described.

The medicine pouch 2 delivered from hospital or dispensary is attached to one of the engaging openings corresponding to the designated part of the day on which the first dosage is to be taken. On the first dosage, the tag 6 is removed from the engaging opening, one dose of medicine is taken, and then the medicine pouch is attached to the engaging portion corresponding to the next designated part of the day.

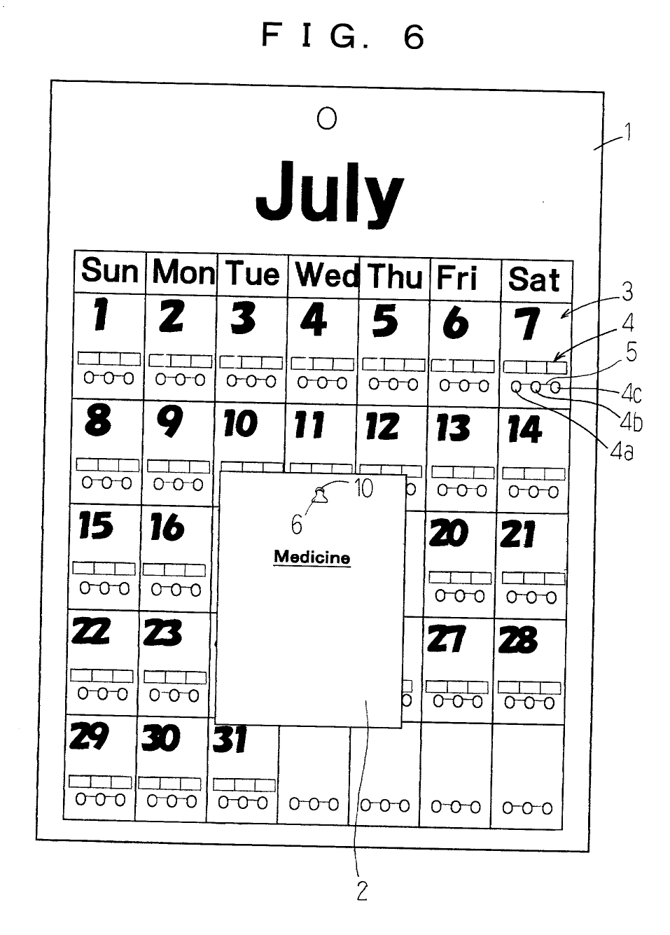

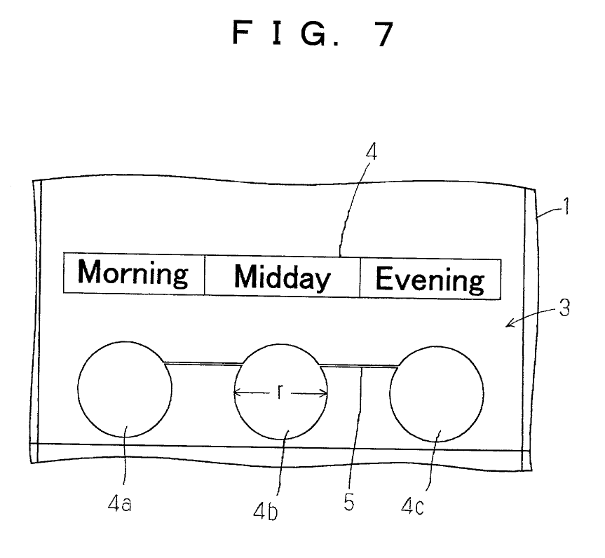

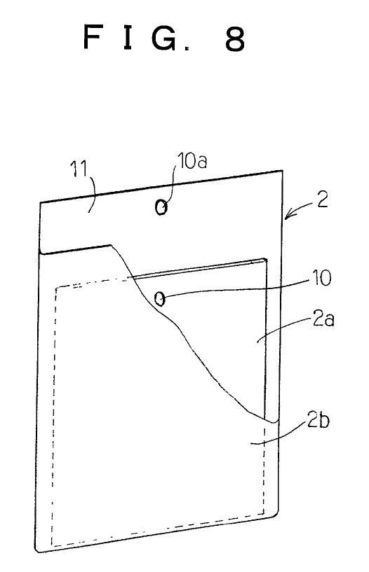

Another embodiment of the present invention will now be described with reference to FIGS. 6 and 7.

The calendar 1 for administrating medicine of the present embodiment is also printed on a sheet. The calendar includes designations of dates of one month as shown in FIG. 6. The days of one week are printed so as to align crosswise. Each date section 3 subdivided by frames also has designations 4 on the part of the day such as “morning”, “midday”, and “evening” for which the medicine is to be taken. Further, engaging openings 4a, 4b, and 4c corresponding to each designation on the part of the day respectively are provided through the sheet. A medicine pouch 2 is adapted to be hanging on the opening by means of a tag 6.

The engaging openings 4a, 4b, and 4c corresponding respectively to each designation on the part of the day are as shown enlarged in FIG. 7 communicated with each other through a slit or a communicating portion 5. The communicating portion 5 can communicate the engaging openings 4a, 4b, and 4c of certain one day with each other, the engaging openings of few days, or those of one week.

A pouch 2a delivered from hospital or dispensary accommodating prescribed medicine can be used as it is. In some cases, a larger medicine pouch 2b of plastic film can be used as the medicine pouch 2 accommodating the medicine pouch 2a. The pouch includes a flap 11 at the upper end portion of the backside sheet of the pouch and an opening 10a provided through the flap for passing the head of the tag.

The breadth (R) of the head 7 is larger than the lateral width (r) of the engaging opening, the width (N) of the neck 9 is smaller than both of the lateral width (r) of the engaging opening and the lateral width of the opening 10a, and the breadth (W) of the shoulder 8 is larger than the lateral width of the opening 10a, so that the head 7 of the tag 6 can be inserted into the engaging opening 4a, 4b, 4c and then engaged with the sheet of the calendar.

The method for using the above described calendar for administrating medicine will now be described.

After inserting the head 7 of the tag 6 through the opening of the medicine pouch, the same head 7 is inserted through the communicating portion 5 connecting the opening 4a for dosing after breakfast and the opening 4b for dosing after lunch, and then the head is displaced to the opening 4a and drop it into the opening 4a to attach the medicine pouch at the opening 4a.

Upon taking the medicine after breakfast, the tag is pulled up to the upper portion of the opening 4a and displaced it along the communicating portion 5 to the opening 4b for dosing after lunch, and then drop it into the opening 4b. Thus the medicine pouch is attached at the opening 4b.

The similar sequence will be taken after lunch to displace the tag though the communicating portion 5 into the opening 4c. The medicine pouch can thus be attached at the position for dosing after evening meal.

As can be seen from the above, the cumbersome operation of previously described embodiment that the removing and attaching of the medicine pouch are to be repeated every time when the one dose of medicine had taken can be avoided in the present embodiment, once the medicine pouch is attached to the engaging opening 4a.

Upon taking the medicine after evening meal, the tag is removed from the engaging opening 4c for dosing after evening meal and then attached to the opening 4a for dosing after breakfast provided through the section of the next day.

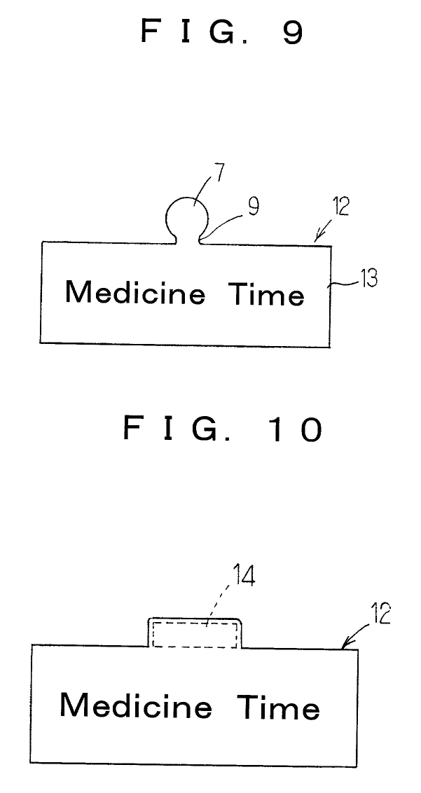

Although in the above mentioned embodiments the medicine pouch 2 is adapted to be attached directly to the calendar 1, a card having such a designation that “Medicine Time” as shown in FIG. 9 or “have you taken the medicine ?”, or a administration instructing label 12 of tag type may also be attached to the calendar 1.

The administration instructing tag 12 also has a head 7 substantially the same as that of the above mentioned tag 6, a narrow neck 9 positioned between the head and the body 13 of the tag. The dimensional relation and the manner of engagement with the engaging openings 4a, 4b, 4c are substantially the same as that of the tag. The head 7 is adapted to be hanging on the engagement opening of the required part of the day of the calendar.

In this embodiment, it must be required to confirm the instructions found on the administration instructing tag applied on the intended part of the day, pick the medicine out of the pouch to take it, and then displace the tag to the next part of the day.

Further, the administration instructing tag may optionally be provided on its backside along the upper marginal portion with the adhesive 14 as shown in FIG. 10 rather than the head and the neck. In such a case, the tag can be attached through the adhesive 14 on the required spot on the day. The preferred material for the adhesive is, for example, an acrylic adhesive mass good at its releasability, i.e. the peeling off and the applying on of it can be effected repeatedly.

In this embodiment, it must be required to confirm the instructions found on the administration instructing tag applied onto the intended part of the day, pick the medicine out of the pouch and take it, and then displace the tag to the next part of the day.

The tag can be applied on the required part 4 of the day of the calendar so that no engaging openings are required to make through the designate parts 4 of the day of the calendar.

Although in the above mentioned embodiments the one month calendar is provided of the sheet, the calendar of the one and the next months can be provided on both of the front and back sides of the sheet. In this case, the engaging openings of the front side must be common with those of the backside, so that the positioning of the engaging openings and the alignment of the calendar of the one month with that of the next month should be adjusted. The calendar can be a block calendar each page of which includes only one day.

If blank space or spaces are remained along the upper and/or lower marginal portions of the calendar, any advertisement of medical institutions, pharmaceutical companies, or dispensaries can be printed thereon.

The calendar of the present invention can be used for instructing the timing of taking medicines of oral administration as well as medicines to be applied externally such as collyrium and liniment.

The calendar of the present invention will indicate clearly the designated part of the day for which the medicine is to be taken subsequently. The medicine pouch and the administration instructing tag hung on the calendar will leap to the eyes. This will lead to take the medicine as prescribed.

The calendar of the present invention is simple in its structure and can be produced economically. In this connection, the practical advantage that hospital and dispensary can use the calendar for the guidance of the administration of the medicine.

While particular embodiments of the present invention have been illustrated and described, it should be obvious to those skilled in the art that various changes and modifications can be made without departing from the spirit and scope of the invention.

What is claimed is,

1. A calendar for administrating medicine is provided on the respective date section thereof with designations on the part of the day such as “morning”, “midday”, and “evening” for which the medicine is to be taken.

2. A calendar for administrating medicine is provided on the respective date section thereof with designations on the part of the day such as “morning”, “midday”, and “evening” for which the medicine is to be taken, and a medicine pouch to be attached removable on one of the designations on the part of the day.

3. A calendar for administrating medicine comprising:
a calendar on the respective date section thereof is provided with designations on the part of the day such as “morning”, “midday”, and “evening” for which the medicine is to be taken and is provided with engaging openings on the portions corresponding respectively to each part of the day; and
a tag including a head and a hook connected by a neck of reduced width, wherein the head of the tag is inserted through an opening formed on the upper portion of a medicine pouch, and then the tag is inserted with the pouch through the intended one of the engaging openings to engage the head with the back side of the sheet of the calendar to hang the medicine pouch.

4. The calendar according to claim 3, wherein:
the tag is made of a material of slight elasticity, and the breadth of the head is larger than the diameter of the engaging opening, so that the head is urged to be deformed to reduce the breadth thereof to the lateral width of the engaging opening upon inserted into the engaging opening and then recovered elastically to its original shape on the back side of the sheet and engaged with the back side.

5. A calendar for administrating medicine is provided on the respective date section thereof with designations crosswise on the part of the day such as “morning”, “midday”, and “evening” for which the medicine is to be taken, and is also provided with laterally aligned engaging openings on the portions corresponding to the parts of the day, the engaging openings are communicated with each other through a slit or communicating portion; and
a tag including a head and a hook connected by a neck of reduced width, wherein the head of the tag is inserted through an opening formed on the upper portion of a medicine pouch, and then the tag is inserted with the pouch through the intended one of the engaging opening to engage the head with the back side of the sheet of the calendar to hang the medicine pouch.

6. A calendar for administrating medicine is provided on the respective date section thereof with designations on the part of the day such as “morning”, “midday”, and “evening” for which the medicine is to be taken, wherein an administration instructing tag can be attached removably on the calendar.

7. The calendar for administrating medicine as claimed in claim 6 wherein the administration instructing tag can be attached removably by an adhesive mass good at its releasability.

8. A calendar for administrating medicine is provided on the respective date section thereof with designations crosswise on the part of the day such as “morning”, “midday”, and “evening” for which the medicine is to be taken, and is also provided with laterally aligned engaging openings on the portions corresponding to the parts of the day, the engaging openings are communicated with each other through a slit or communicating portion; and
an administration instructing tag including a head and a hook connected by a neck of reduced width, wherein the head of the administration instructing tag is inserted through an opening formed on the upper portion of a medicine pouch, and then the administration instructing tag is inserted with the pouch through the intended one of the engaging opening to engage the head with the back side of the sheet of the calendar to hang the medicine pouch.
